(19) United States
(12) Patent Application Publication
(10) Pub. No.: US 2009/0117786 A1
(43) Pub. Date: May 7, 2009

(54) ELECTRICAL CONNECTOR ASSEMBLY

(76) Inventors: Harald Westkamp, Neuss (DE); Guenter Ploehn, Neuss (DE)

Correspondence Address: 3M INNOVATIVE PROPERTIES COMPANY, PO BOX 33427, ST. PAUL, MN, 55133-3427, US

(21) Appl. No.: 11/908,872

(22) PCT Filed: Mar. 16, 2006
(86) PCT No.: PCT/US06/09989

§ 371 Date: Mar. 13, 2008

(30) Foreign Application Priority Data
Mar. 18, 2005 (EP) 05102174.9

(51) Int. Cl. H01R 24/04

(52) U.S. Cl. 439/676

(57) ABSTRACT

The electrical connector assembly comprises first (12) and second (14) connectors each including an array of first (24) and second (48) contact elements, respectively. One of the connectors is provided with a collar (30) surrounding the array of contact elements and projecting there-beyond. The other connector is provided with guiding elements (38) projecting from the respective connector. Within the array defined by the collar there is provided an abutment edge (56, 60, 66, 74, 76) extending within the area of contact elements of that connector and above these contact elements. The greatest distance (52,78) between the collar portions and the abutment edge is smaller than the width (50) of the guiding elements so that in case of a misalignment where the connectors are displaced relative to each other, the guiding element by the collar and the abutment edge is prevented from contacting the contact elements surrounded by the collar.

### FIELD

The present invention relates to an electrical connector assembly having first and second mating connectors and, in particular, having a header and a multiple wire cable harness which are blind mateable.

### BACKGROUND

Connector assemblies for connecting multiple wire cables (e.g. multiple coaxial cables or multiple twisted pair cables) are known in the art. Such connectors are used, for example, in telecommunication applications to connect a multiple wire cable to an electronic card at the face plate of a 19″ rack card. Such a connector as well as a connector shell are described, for example, in WO-A-03/012934, WO-A-04/008580, WO-A-04/008482, EP-A-1 432 078, and EP-A-0 952 367.

Modern telecommunication applications require an increased density of mating connector elements in a connector assembly. For example the one contact elements are designed as pin terminals while the other contact elements are arranged in terminal cavities. The terminal cavities have to be aligned with the pin terminals when matingly engaging the two connectors of the connector assembly.

WO-A-98/02942 discloses an electrical interconnection system using multiple connector channels or slots for connecting printed circuit boards for applications including board stacking, vertical to vertical, mother to daughter, vertical to right angle and/or straddle, and, in particular, relates to a fine pitch connector having plug and socket each having four rows of electrical contact elements.

In an electrical connector assembly it is known to provide mate assist features such as guiding elements on the one connector and guiding element recesses in the other connector. Often these guiding features are also used for polarizing purposes in order to prevent engagement of the two connectors when the same are in an improper orientation relative to each other. Examples for the prior art described before can be found in U.S. Pat. No. 4,761,144, U.S. Pat. No. 5,037,323, U.S. Pat. No. 5,080,604, U.S. Pat. No. 5,129,831, U.S. Pat. No. 5,147,225, U.S. Pat. No. 5,147,226, U.S. Pat. No. 5,161,996, U.S. Pat. No. 5,205,755, U.S. Pat. No. 5,211,585, U.S. Pat. No. 5,466,171, U.S. Pat. No. 5,647,785, and U.S. Pat. No. 1,104,048. The guiding features of these known connector assemblies assist in a so-called blind mating in which the two connectors have to be engaged with each other without the technician being able to fully verify proper alignment of the two connectors upon engagement.

One problem with guiding elements arranged on one of the connectors is that these guiding elements which project from the housing of the respective connector could accidentally happen to contact the contact elements of the respective other connector in case of a misalignment of both connectors upon engagement. Since the risk of misalignment has to be regarded particularly in a blind mating situation, hazards from accidental contact of the guiding elements of the one connector with the contact elements of the other connector have to be minimized. In particular in case of pin terminals in headers or the like, the pin terminals have to be protected from accidental contact with projecting guiding elements of the respective other connector because the pin terminals are freely accessible in the direction of mating engagement of the connectors.

EP-B-0 443 492 and U.S. Pat. No. 5,173,063 both disclose receptacle connectors having protected power contacts. These known connectors are provided with several pairs of guiding posts arranged within the array of pin terminals wherein the pairs of guiding posts as well as the guiding posts for each pair are spaced apart from each other. The guiding posts of each pair have different cross sections so as to provide a polarizing and keying means. The distances between the guiding posts of each pair as well as between these guiding posts and the adjacent sections of a collar or shroud surrounding the array of contact pins chosen such that standardized foreign objects like a finger or a prope are prevented from making mechanical contact with the pin terminals within the area where the pair of guiding posts is arranged. Accordingly, such an arrangement can be used in order to protect pin terminals provided for transmitting electric power. However, arranging the guiding posts within the array of contact terminals results in reducing the total amount of pin terminals which in particular in modern telecommunication applications requiring a high density of contact elements in the electrical connector assembly is not acceptable.

Accordingly, there is a need for electrical connector assemblies having guiding features and blind mate assist features without the risk of damage caused to the contact elements on the one connector by the projecting guiding elements of the other connector in case of misalignment.

### SUMMARY

According to one aspect of the present invention there is provided an electrical connector assembly comprising
a first connector having a longitudinal main dimension,
a second connector having a longitudinal main dimension,
wherein the first connector comprises an array of first contact elements in the form of pin terminals and arranged in at least two rows, and a collar surrounding the array of first contact elements and projecting beyond the first contact elements, the collar having two parallel longitudinal portions,
wherein the second connector comprises an array of second contact elements arranged in the same manner as the first contact elements of the first connector, for making electrical contact with the first contact elements,
at least two guiding elements arranged on the second connector and extending therefrom in a direction for mating the first and second connectors, wherein the guiding elements are arranged at opposite ends of the array of second contact elements in the longitudinal dimension of the second connector,
at least two guiding element recesses formed in the first connector for receiving the two guiding elements of the second connector when mating the first and second connectors, the guiding element recesses being arranged at opposite ends of the array of the first contact elements in the longitudinal dimension of the first connector, and
an abutment edge arranged on the first connector and extending within the array of the first contact elements therebetween and above the first contact elements along the longitudinal dimension of the first connector, the abutment edge provided for preventing the guiding elements from accidental engagement with the first contact elements of the first connector,
wherein each guiding element has a length in a dimension perpendicular to the longitudinal dimension of the second connector wherein the guiding element length is greater than the greatest distance between the longitudinal collar portions and the abutment edge.

According to one embodiment of the invention the electrical connector assembly comprises first and second connectors each having a longitudinal main dimension. The first connector comprises an array of pin terminals (first contact elements) and a collar or shroud surrounding the array of first contact elements. The collar projects beyond the tips of the first contact elements. The second connector comprises an array of second contact elements arranged to mate with the first contact elements. In order to assist in guiding and aligning of the two connectors, the second connector is provided with projecting guiding elements arranged at opposite sides of the array of second contact elements. The first connector is provided with corresponding guiding element recesses for receiving the guiding elements when mating the first and second connectors. The guiding elements have length dimensions perpendicular to the longitudinal main dimensions of the first and second connectors.

In the electrical connector assembly according to this embodiment of the invention there is provided an abutment edge. This abutment edge extends above the first contact elements i.e. at a level higher than the tips of the first contact elements and, in particular, substantially at the same height as the edge of the collar. Basically, the abutment edge can be higher than the collar at its longitudinal portions. The abutment edge extends between adjacent first contact elements and in the generally longitudinal dimension of the first connector. The abutment edge can take any course and, in particular, can be straight and parallel to the longitudinal main dimension. As an alternative, the abutment edge can be curved within the array of first contact elements so as to be displaced from row to row of the array of first contact elements. The abutment edge does not cover the first contact elements so that the first contact elements are always freely accessible in the direction of mating the first and second connectors.

The abutment edge together with the collar of the first connector serves for protecting the first contact elements from a contact with the guiding elements. Namely, the greatest distance between the abutment edge and the longitudinal portions of the collar is smaller than the width of each guiding element. Accordingly, in case of a misalignment of the two connectors when engaging them, the guiding element of the second connector which in this situation due to the misalignment is above the array of first contact elements, will contact the collar and the abutment edge and, accordingly, will be prevented by them from any contact with the first contact elements. Accordingly, the specific dimensional arrangement of the abutment edge, the longitudinal collar portions, the distance therebetween, and the width of the guiding elements, respectively, allows the pin terminal contact elements on the one connector to be protected from being contacted by the projecting guiding elements on the respective other connector, when in case of a blind mating both connectors are in misalignment when engagement of both connectors is tried.

Basically, the electrical connector assembly can be used with any type of first and second connectors, wherein at least one of them is provided with freely accessible upwardly extending contact elements, while the other connector is provided with projecting guiding and aligning elements. Accordingly, the first and second connectors can be designed as plug and socket connectors or as surface of board mount headers and multiple wire cable harnesses. Also the guiding and alignment elements as well as corresponding recesses can be provided with different shapes and projections in order to provide a polarizing means for preventing engagement of the connectors when in an improper orientation relative to each other. Preferably, the guiding elements and guiding element recesses are arranged outside of the array of first and second contact elements, respectively, so as to provide the available space between the guiding elements and the guiding element recesses, respectively, with as much first and second contact elements as possible thereby increasing the total amount of contact elements as well as their density. The guiding elements can be arranged adjacent the opposite ends of the array of first contact elements. The same is true for the guiding element recesses and the array of second contact elements. The guiding element recesses can be arranged within the area defined by the collar. In particular, the collar can form part of the guiding element recesses. As an alternative, the guiding element recesses can be arranged outside of the collar.

The abutment edge of one of the first and second connectors of the electrical connector assembly according to at least one embodiment of the invention can be formed as a bar extending between the collar portions adjacent the opposite ends of the array of first contact elements in longitudinal dimension of the first connector which collar portions are perpendicular to those collar portions extending in longitudinal dimension of the first connector. The two small perpendicular collar portions are arranged outside the array of first contact elements. The abutment bar can be supported within the array of first contact elements by posts or the like support projections extending from a carrier body of the first connector carrying and holding the first contact elements.

As an alternative, the abutment edge is formed on an abutment wall projecting from the carrier body and extending parallel to the first contact elements. The abutment wall or edge typically extends continuously within the array of first contact elements although providing several abutment edge portions arranged side by side with gaps therebetween can also be employed. The gaps between adjacent abutment wall or edge portions have to be smaller than the width of the guiding elements in the longitudinal dimension of the first and second connectors. This guarantees that in case of a misalignment of the first and second connectors the guiding element cannot enter gap between two adjacent abutment edge or wall sections.

As another alternative, abutment edge portions need only to be provided within the array of first contact elements close to its opposite ends in the longitudinal dimension of the connectors. Namely, assuming that a misalignment of the two connectors will merely take place with maximum possible displacement of both connectors e.g. limited by the surroundings in which the connector is provided, a protection of all the first contact elements in the middle portion of the array of first contact elements is not necessary.

### BRIEF DESCRIPTION OF THE DRAWINGS

A full and enabling disclosure of the present invention, including the best mode thereof, enabling one of ordinary skill in the art to carry out the invention, is set forth in greater detail in the remainder of the specification, including reference to the accompanying drawing in which

FIG. 1 is a side view of an electrical connector assembly with the first and second connectors being spaced apart from each other,

FIG. 2 is a plan view of that connector which is provided with pin terminals as contact elements and an abutment edge arranged in the middle of the pin terminal array and extending longitudinally,

FIG. 3 is a bottom view of that connector which receives the pin terminals and which is provided with the projecting guiding elements,

FIG. 4 is a sectional view taken along the line IV-IV of FIG. 1,

FIG. 5 shows the situation in which engagement of the two connectors is performed while the two connectors are misaligned relative to each other,

FIG. 6 is an isometric view on a larger scale showing that in case of misalignment the guiding means are prevented from being inserted into the connector provided with the pin terminals,

FIG. 7 a plan view of the connector provided with the pin terminals and having abutment edges only at the longitudinal ends of the connector according to another embodiment of the invention,

FIG. 8 a plan view of the connector provided with the pin terminals and having several adjacent abutment edge portions along the longitudinal dimension of the connector,

FIG. 9 a plan view of the connector provided with the pin terminals and having an abutment edge located outside of the middle of the connector, and

FIG. 10 a plan view of the connector provided with the pin terminals and having an abutment edge extending in a generally longitudinal direction but with steps therebetween.

### DESCRIPTION OF PREFERRED EMBODIMENTS

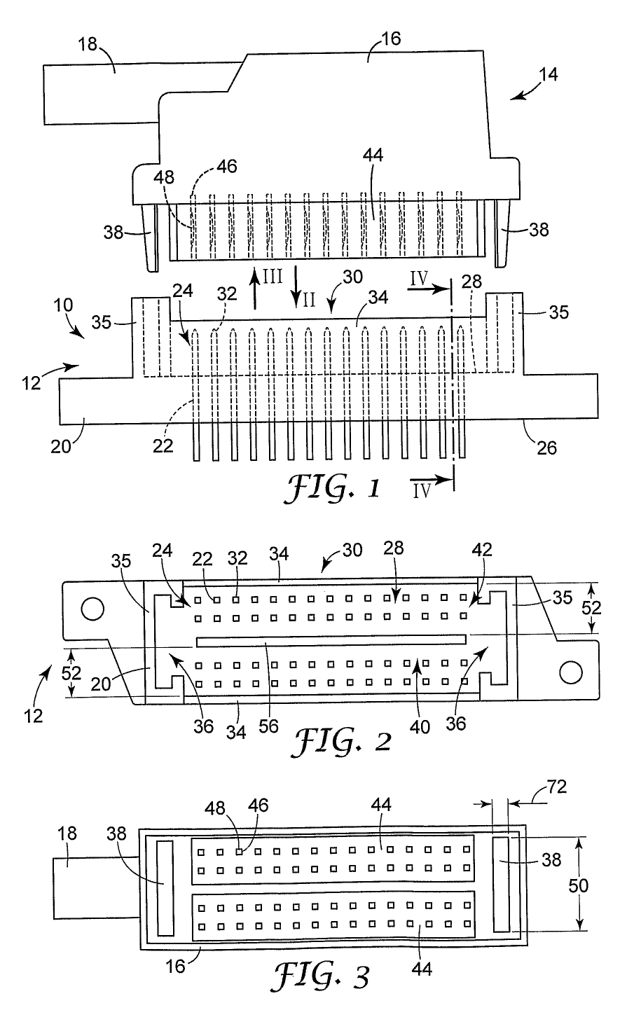

FIG. 1 shows one embodiment of an electrical connector assembly 10 provided with a first connector 12 and a mating second connector 14. In this embodiment the first connector 12 is formed as a header and, in particular, a board mountable header while the second connector 14 is designed as a shell 16 from which a multiple wire cable 18 extends. However, it has to be noted that any other type of first and second connectors can be used as long as one of the connectors is provided with freely accessible contact elements and the other connector is provided with projecting guiding elements as discussed later.

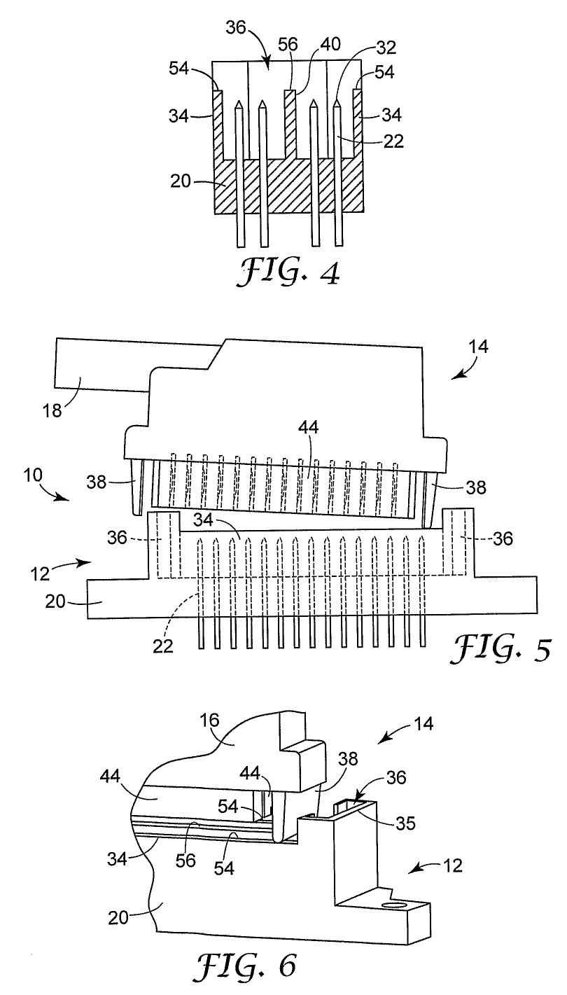

As can be seen from FIGS. 1, 2, and 4, the first connector 12 comprises a body 20 carrying a plurality of pin terminals 22 constituting first contact elements 24. The pin terminals 22 extend through the body 20 and project beyond its lower and upper sides 26,28. At the upper side 28 of the body 20 there is provided a collar 30 surrounding the area of pin terminals 22 and extending beyond the tip portions 32 of the pin terminals 22. As can be seen best in FIG. 2, the collar 30 is provided with two parallel longitudinal portions 34 extending in the longitudinal main direction of the first connector 12 and two portions 35 extending to perpendicular to the longitudinal portions 34 for connecting the same. At the longitudinal ends of the first connector 12 there are arranged two guiding element recesses or receiving portions 36 for receiving mating guiding elements 38 provided on the second connector 14 as will be explained in more detail hereinbelow. Moreover, the first connector 12 is provided with a middle wall 40 extending upwardly from the body 20 and between the array 42 of pin terminals 22 which are arranged in individual columns and rows although other arrangements for the pin terminals 22 are also possible. The middle wall 40 extends in the longitudinal main direction of the first connector 12 and projects beyond the tips 32 of the pin terminals 22. In particular, the middle wall 40 terminates at the same height above the body 20 as the longitudinal portions 34 of the collar 30 do. The upper edges of the longitudinal collar portions 34 and the middle wall 40 form abutments for preventing the pin terminals 22 from an accidental contact with the guiding elements 38 as will be explained hereinbelow.

The second connector 14 is provided with one or several sockets 44 (two sockets in this embodiment, see FIG. 3) wherein each socket comprises a plurality of terminal cavities 46 each provided with at least one second contact element 48 for making electrical contact with the pin terminals 22 of the first connector 12. The terminal cavities 46 are arranged in the same manner as the pin terminals 22. At the opposite ends in the longitudinal main direction of the second connector 14 there are provided the two guiding elements 48 which have a substantially rectangular cross section and which are shaped slightly conically (in particular see FIG. 1). The guiding elements 38 project from the shell 16 of the first connector 12 and extend beyond the socket or sockets 44 of the first connector 12.

Engagement of the two connectors 12 and 14 for making simultaneous multiple electrical connection between the respective pin terminals 22 and the second contact elements 48 within the terminal cavities 46 is facilitated by the guiding and alignment feature provided by the guiding elements 38 and the mating guiding element recesses 36. While these alignment and guiding features are helpful for mating the two connectors 12 and 14 when fully verifiable visually, the projecting guiding elements 38 could damage parts of the first connector 12 and, in particular, the pin terminals 22 if the two connectors 12,14 are engaged when displaced relative to each other (see FIG. 5). According to the invention any risk of damage is reduced significantly in that the pin terminals 22 are protected from mechanical contact with the guiding elements 38 by the collar 30 and, in particular, the middle wall 40. Namely, the width 50 of the guiding elements 38 (see FIG. 3) is larger than the distance 52 between the middle wall 40 and each of the longitudinal collar portions 34. Accordingly, if due to a misalignment between the two connectors 12 and 14, one of the guiding elements 38 will be moved towards the array 42 of pin terminals 22, the guiding element 38 merely can contact the abutment edges 54 and 56 of the collar 30 and the middle wall 40, thereby preventing the guiding element 38 from coming into mechanical contact with the pin terminals 22 (see FIG. 5 and, in particular, FIG. 6). Besides this protection function, the middle wall 40 also serves for supporting the guiding feature in that when the two connectors 12 and 14 are probably aligned the middle wall 40 enters into the gap 58 between the two sockets 44 of the first connector 12.

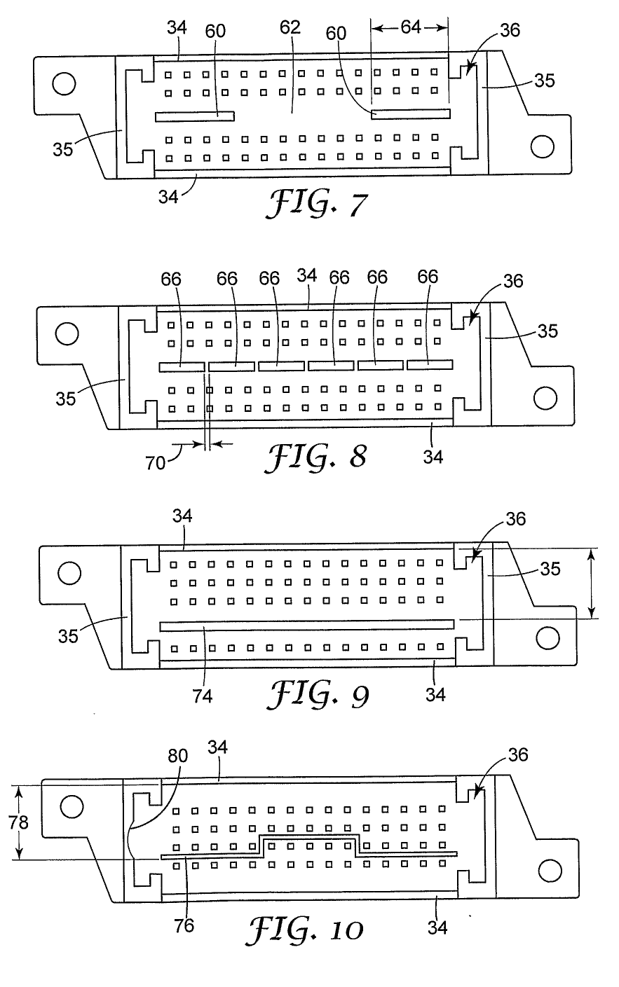

As evident from the above, the abutment edge 56 of the first connector 12 in connection with the width 50 of the guiding elements 38 of the second connector 14 serves for protecting the pin terminals 22 from an accidental contact with the guiding elements 38. In order to provide this protection means, the abutment edge 56 not necessarily needs to continuously extend throughout the array 42 of pin terminals 22. In some applications it might be sufficient to have abutment edge portions 60 adjacent the guiding element recesses 36 with the middle portion 62 between the abutment edge portions 60 being freely accessible. This embodiment of the second connector 12 is shown in FIG. 7. In this embodiment of the present invention it is assumed that the maximum possible displacement between the first and connectors when disengaging the same is limited to the longitudinal extension 64 of each abutment edge portion 60.

Another alternative embodiment of the first connector is shown in FIG. 8. According to this embodiment, the abutment edge comprises a plurality of abutment edge portions 66 located adjacent to each other and along the full longitudinal length of the array 42 of the pin terminals 22. Between respective adjacent abutment edge portions 66 there are formed gaps 68 having a width 70. The width 70 of the gaps 68 is smaller than the width 72 of the guiding elements 38 (see FIG. 3) at their ends. Accordingly, it is not possible for the guiding element 38 to be inadvertently entered into one of the gaps 68. FIG. 9 shows a further embodiment of the first connector wherein the abutment edge 74 is arranged outside the center between the two longitudinal collar portions 34. The largest distance between the abutment edge 74 and each of the longitudinal collar portions 34 (see the arrow in FIG. 9) is smaller than the length of the guiding elements 38. By this arrangement the abutment edge 74 together with the arrangement and shape of the sockets 44 of the first connector 12 can be used as a polarizing means. Such a polarizing means can also be realized by using guiding elements 38 having different overall shapes and correspondingly shaped guiding element recesses 36 (see for example FIG. 10).

Finally, FIG. 10 shows an embodiment of the first connector in which the abutment edge 76 extends in a generally longitudinal direction but with stepped portions in between. As an alternative thereto, the abutment edge can also extend at an inclination with respect to the longitudinal dimension of the first connector. In both cases the protection feature requires that the maximum distance 78 between the abutment edge 76 and the longitudinal collar portions 34 is less than the width 72 of the guiding elements 38 of the first connector 12. One of the collar portions 35 forming part of the guiding element recesses 36 is provided with a depression 80 facing the guiding element recess, wherein the associated guiding element 38 is provided with a corresponding protrusion (not shown) in order to provide a polarizing means.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. An electrical connector assembly comprising
a first connector having a longitudinal main dimension,
a second connector having a longitudinal main dimension,
wherein the first connector comprises an array of first contact elements in the form of pin terminals and arranged in at least two rows, and a collar surrounding the array of first contact elements and projecting beyond the first contact elements, the collar having two parallel longitudinal portions,
wherein the second connector comprises at least one socket having an array of second contact elements arranged in the same manner as the first contact elements of the first connector, for making electrical contact with the first contact elements,
at least two guiding elements arranged on the second connector and projecting separately from at least one socket in a direction for mating the first and second connectors, wherein the guiding elements are arranged at opposite ends of the array of second contact elements in the longitudinal dimension of the second connector,
at least two guiding element recesses formed in the first connector for receiving the two guiding elements of the second connector when mating the first and second connectors, the guiding element recesses being arranged at opposite ends of the array of the first contact elements in the longitudinal dimension of the first connector, and
an abutment edge arranged on the first connector and extending within the array of the first contact elements therebetween and above the first contact elements along the longitudinal dimension of the first connector, the abutment edge provided for preventing the guiding elements from accidental engagement with the first contact elements of the first connector,
wherein each guiding element has a length in a dimension perpendicular to the longitudinal dimension of the second connector wherein the guiding element length is greater than the greatest distance between the longitudinal collar portions and the abutment edge.

2. The electrical connector assembly according to claim 1, wherein the abutment edge extends between two adjacent rows of first contact elements of the first connector.

3. The electrical connector assembly according to claim 1, wherein the abutment edge is formed on an abutment wall extending parallel to the first contact elements.

4. The electrical connector assembly according to claim 3, wherein the abutment wall extends continuously within the array of first contact elements.

5. The electrical connector assembly according to claim 3, wherein each guiding element of the second connector has a width in the longitudinal dimension of the second connector and wherein the abutment wall comprises adjacent wall sections spaced from each other for forming gaps between respective adjacent wall sections and wherein each gap has a width in the longitudinal dimension of the first connector with the gap width being smaller than the guiding element width.

6. The electrical connector assembly according to claim 1, wherein the abutment edge comprises at least two abutment edge sections arranged adjacent the opposite ends of the array of first contact elements, respectively.

7. The electrical connector assembly according to claim 1, wherein the guiding element recesses of the first connector are arranged within the area defined by the collar of the first connector.

8. The electrical connector assembly according to claim 1, wherein the collar forms part of each of the guiding element recesses.

9. The electrical connector assembly according to claim 1, wherein each pair of associated guiding element and guiding element recess has a different shape for allowing mating of the first and second connectors in only one orientation of the first and second connectors.

10. The electrical connector assembly according to claim 1, wherein the first connector is a board mountable header and the second connector comprises a shell operable manually for mating engagement with and disengagement from the surface mountable header.

11. The electrical connector assembly of claim 1 wherein the electrical connector assembly is a plug and socket connector assembly.

12. The electrical connector assembly of claim 1 further comprising a wire cable harness.

13. A first electrical connector matable to a second connector having an array of second contact elements arranged in at least one socket and at least two guiding elements projecting separately from the at least one socket in a direction for mating to the first electrical connector the guiding elements arranged at opposite ends of the array of second contact elements in the longitudinal dimension of the second connector, each guiding element having a length in a dimension perpendicular to the longitudinal dimension of the second connector and a width in the longitudinal dimension of the second connector said first electrical connector comprising:
an array of first contact elements in the form of pin terminals and arranged in at least two rows and a collar surrounding the array of first contact elements and projecting beyond the first contact elements, the collar having two parallel longitudinal portions,
at least two guiding element recesses formed for receiving the two guiding elements of the second connector, the guiding element recesses being arranged at opposite ends of the array of the first contact elements in the longitudinal dimension of the first connector, and
an abutment edge extending within the array of first contact elements therebetween and above the first contact elements along the longitudinal dimension of the first connector, the abutment edge provided for preventing the guiding elements of the second connector from accidental engagement with the first contact elements of the first connector,
wherein the greatest distance between the longitudinal collar portions and the abutment edge is less than the guiding element length.

14. The first electrical connector according to claim 13, wherein the abutment edge extends between two adjacent rows of first contact elements.

15. The first electrical connector according to claim 13, wherein the abutment edge is formed on an abutment wall extending parallel to the first contact elements.

16. The first electrical connector according to claim 15, wherein the abutment wall extends continuously within the array of first contact elements.

17. The first electrical connector according to claim 15, wherein the abutment wall comprises adjacent wall sections spaced from each other for forming gaps between respective adjacent wall sections and wherein each gap has a width in the longitudinal dimension of the first connector with the gap width being smaller than the width of the guiding elements of the second connector.

18. The first electrical connector according to claim 13, wherein the abutment edge comprises at least two abutment edge sections arranged adjacent the opposite ends of the array of first contact elements, respectively.

19. The first electrical connector according to claim 13, wherein the guiding element recesses are arranged within the area defined by the collar.

20. The first electrical connector according to claim 13, wherein the collar forms part of each of the guiding element recesses.

21. The first electrical connector according to claim 13, wherein the first electrical connector is a board mountable header.

22. The first electrical connector of claim 13 further comprising a wire cable harness.

23. A second electrical connector matable to a first connector having an array of first contact elements in the form of pin terminals and arranged in at least two rows, and a collar surrounding the array of first contact elements and projecting beyond the first contact elements, the collar having two parallel longitudinal portions, at least two guiding element recesses for receiving guiding elements of the second connector, the guiding element recesses being arranged at opposite ends of the array of the first contact elements in the longitudinal dimension of the first connector, and an abutment edge extending within the array of the first contact elements therebetween and above the first contact elements along the longitudinal dimension of the first connector, the abutment edge provided for preventing guiding elements of the second connector from accidental engagement with the first contact elements of the first connector, said second connector comprising:
at least one socket having an array of second contact elements for making electrical contact with the first contact elements of the first connector,
at least two guiding elements projecting separately from at least one socket in a direction for mating with the first connector, wherein the guiding elements are arranged at opposite ends of the array in the longitudinal dimension of the second connector,
wherein each guiding element has a length in a dimension perpendicular to the longitudinal dimension of the second connector wherein the guiding element length is greater than the greatest distance between the longitudinal collar portions and the abutment edge of the first connector.

24. The second electrical connector according to claim 23, wherein the second connector comprises a shell operable manually for mating engagement with and disengagement from a surface mountable header.

25. The first electrical connector of claim 23 further comprising a wire cable harness.
